(19) United States
(12) Patent Application Publication
(10) Pub. No.: US 2019/0000049 A1
(43) Pub. Date: Jan. 3, 2019

(54) Fishing System and Method to Enhance the Fishing Experience

(71) Applicant: P Tech, LLC, Effingham, IL (US)

(72) Inventors: Peter M. Bonutti, Manalapan, FL (US); Justin E. Beyers, Effingham, IL (US)

(21) Appl. No.: 16/068,597

(22) PCT Filed: Jan. 6, 2017
(86) PCT No.: PCT/US17/12517

§ 371 Date: Jul. 6, 2018

Related U.S. Application Data
(60) Provisional application No. 62/275,436, filed on Jan. 6, 2016.

(51) Int. Cl. A01K 73/04; A01K 97/12; A01K 85/00; A01K 73/02; A01K 73/10; A01K 91/18

(52) U.S. Cl. CPC A01K 73/04; A01K 97/125; A01K 91/18; A01K 73/025; A01K 73/10; A01K 85/00

(57) ABSTRACT

A fishing system includes a submersible fishing implement for being received in a body of water and configured for capturing one or more fish. An implement driver is configured to drive movement of the submersible fishing implement through the body of water. A data collection system includes one or more sensors for sensing one or more fishing parameters and transmitting a fishing parameter signal representative of the one or more fishing parameters. A controller is operatively connected to the data collection system to receive the fishing parameter signal and to determine based on the fishing parameter signal a selected fishing location. The controller is further configured to transmit a navigation signal to the implement driver operative to control the implement driver to drive movement of the submersible fishing implement toward the selected fishing location.

### FIELD

The present disclosure relates generally to a fishing system and more specifically to a fishing system that automates positioning and/or retrieval of fishing implements such as lures, nets, hooks, etc.

### BACKGROUND

Many techniques and devices can be used to deploy fishing lures and/or nets in a body of water and to retrieve fish caught using the lure or net. For example, lures can be tied to the end of fishing line that is cast using a fishing rod and retrieved using a reel. Similarly, nets can be deployed in the water and drawn into a boat using pull lines, winches, and/or other mechanical devices. Multiple lures can be connected to the same fishing line to be deployed at spaced apart positions in a body of water using various rigging techniques. And weights and other devices can be used to deploy a fishing lure at a desired depth. In the water, various techniques may be used to manipulate the lure to move in a way that attracts fish.

Various parameters can affect the likelihood of catching fish in a body of water. For example, the proximity of fish to a lure or net, weather conditions, characteristics of aquatic structure, current and tidal conditions, water temperature, etc. can all play a role in attracting fish to a lure or drawing fish into a net. Various techniques are known for determining these parameters. For example, sport fisherman often use observation towers (e.g., Tuna Towers) to position themselves high above the surface of the water where they can view water conditions, aquatic structure, and in some cases the location of fish in the water. In addition, various sensors can be used to sense the parameters that are relevant to catching fish. For example, satellite sensors can provide measurements of water currents and water temperatures, as well as identifying the locations of schools of fish and debris, which can aid an angler in avoiding obstacles (e.g., underwater structures, boat lines, objects, etc.) that hinder fishing. Radar systems and sonar systems are utilized to detect the location of fish in the water. And various sensors, such as temperature sensors, pressure sensors, and the like, are often used to provide a fisherman with data about environmental conditions that are related to fishing strategy. In general, data about fishing conditions can be used to enhance fishing outcomes by attracting larger numbers of fish to a lure or net, particularly when the techniques and equipment of the fisherman are properly coordinated with the data.

Even after bringing the bait and the desired fish into close proximity, technique and equipment plays a role in drawing fish into a boat or onto shore. Any unnatural movement can spook a fish or cause it not to strike or be drawn into a net. And in angling specifically, the equipment must be capable of transmitting forces applied to the lure to the angler to allow strikes to be detected and distinguished. Even once a strike is detected, a hook must be properly set in the fish to prevent the fish from coming off of the hook or line. Conventional hooks are rigid devices that rely on the mechanical action of the jaws of the fish for engagement.

### SUMMARY

In one aspect, a fishing system includes a submersible fishing implement for being received in a body of water and configured for capturing one or more fish. An implement driver is configured to drive movement of the submersible fishing implement through the body of water. A data collection system includes one or more sensors for sensing one or more fishing parameters and transmitting a fishing parameter signal representative of the one or more fishing parameters. A controller is operatively connected to the data collection system to receive the fishing parameter signal and to determine based on the fishing parameter signal a selected fishing location. The controller is further configured to transmit a navigation signal to the implement driver operative to control the implement driver to drive movement of the submersible fishing implement toward the selected fishing location.

Other aspects and features will be apparent and/or pointed out hereinafter.

### BRIEF DESCRIPTION OF THE DRAWINGS

FIG. 1A is a schematic top plan view of a fishing system;

FIG. 1B is a schematic side elevation of the fishing system;

FIG. 2A is a schematic top plan view of the fishing system with a net replacing fishing rigs shown in FIGS. 1a and 1b;

FIG. 2B is a schematic side elevation of the fishing system shown in FIG. 2a;

FIG. 3A is a schematic illustration of a fishing line of the fishing system shown in FIGS. 1a and 1b;

FIG. 3B is a schematic illustration of the net of the fishing system shown in FIGS. 2A and 2B;

FIG. 4 is a schematic illustration of another fishing line;

FIG. 5A a schematic illustration of a fishing hooks;

FIG. 5B is a schematic illustration of another fishing hook;

FIG. 5C is a schematic illustration of another fishing hook;

FIG. 5D is a schematic illustration of another fishing hook;

FIG. 5E is a schematic illustration of another fishing hook;

FIG. 5F is a schematic illustration of another fishing hook;

FIG. 5G is a schematic illustration of another fishing hook;

FIG. 6 is a schematic illustration of a lure driver;

FIG. 7 is a schematic illustration of an aerial drone supporting fishing sensors;

FIG. 8A is a schematic illustration of a hook and a fish immediately prior to striking the hook; and

FIG. 8B is a schematic illustration of the hook and the fish after striking the hook.

### DETAILED DESCRIPTION

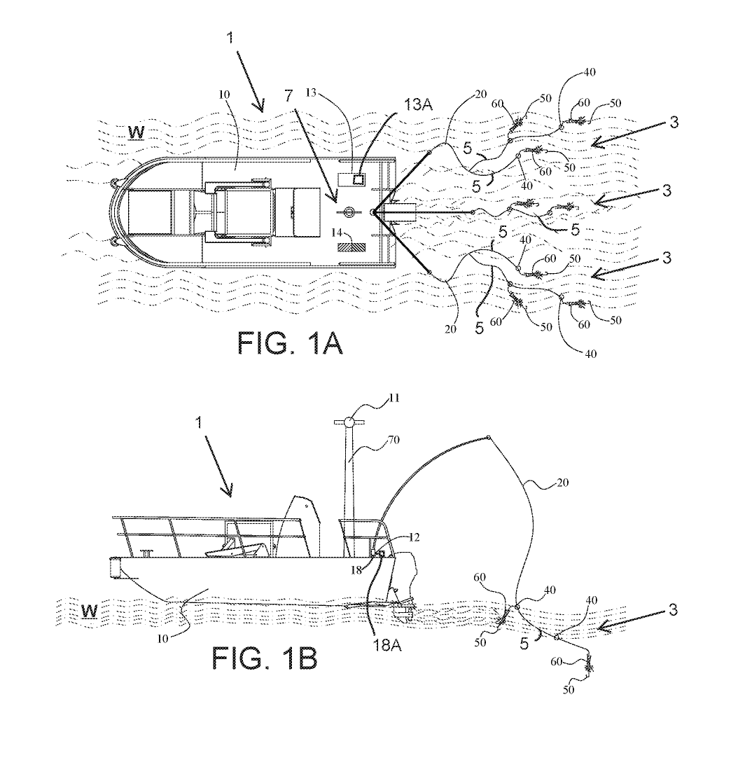

Referring to FIGS. 1A and 1B one embodiment of a fishing system is generally indicated at reference number 1. The fishing system 1 includes a boat 10 floating in a body of water W and a plurality of fishing lines 20 extending from the stem of the boat. Each fishing line 20 is connected at its distal end to a fishing rig (broadly, a submersible fishing implement), generally indicated at 3, which is configured to capture (e.g., hook, catch, grab, or ensnare) one or more fish. As will be explained in further detail below, the fishing system 1 includes a data collection system, generally indicated at 7, configured to sense one or more parameters related to the likely location of fish in the body of water W (e.g., air temperature, water temperature, barometric pressure, fish location, structure location, water depth, fish activity, etc.) and to transmit a signal to a controller 13 representative of the sensed parameters. The controller 13 is configured to evaluate the fishing parameter signal to determine a likely location of fish. The controller 13 is operatively connected to one or more lure drivers 40 (broadly, fishing implement drivers) to control the lure drivers to automatically drive movement of the rigs 3 toward the likely location of the fish.

In the illustrated embodiment, each fishing rig 3 includes a portion of the main fishing line 20 extending to a main line end, and a plurality of leader lines 5 extending from each main line end to respective leader line ends. A lure 60 (“lure” is understood to broadly encompass any form of live or artificial bait or attractant) and a hook 50 are secured to each leader line 5 adjacent the leader line end. Although the illustrated fishing system 1 uses a plurality of multi-lure angling rigs 3 that are cast from the stern of the boat 10, it will be understood that other fishing systems can be configured to automate the movement of other types of fishing implements (e.g., nets, other types of hooked fishing rigs such as a single lure or single hook, etc.) and may be operatively installed at other fishing locations (e.g., on shore, on a pier, on an aerial vehicle, etc.).

In the illustrated embodiment, a lure driver 40 (broadly, an implement driver) is operatively connected to each leader line 5 to drive movement of the lure 60 and the hook 50 connected to the respective leader line. Any suitable type of lure driver for driving movement of the submersible fishing implement (e.g., the lure 60 and the hook 50) through the body of water may be used. For example, in one or more embodiments, the lure driver 40 comprises one of a motor drive, a jet drive, and a propeller drive. Suitably, the lure driver 40 is configured to selectively adjust the depth of the lure 60 and the hook 50. For example, the lure driver 40 can include a ballast tank or trim tank and a pump for selectively filling the tank with water to adjust the buoyancy, and thus the depth, of the driver (and the lure 60). In addition or in the alternative, the lure driver 40 can use directed propulsion from one of a motor drive, a jet drive, and a propeller drive to selectively adjust the depth of the lure driver (and the lure 60). Along with depth adjustments, the illustrated lure driver 40 is configured to drive lateral movement of the lure 60 (e.g., in directions generally parallel to the plane of the surface of the body of water). The lure driver 40 can be powered by an onboard power supply (e.g., a battery, gas canister, etc.) or by a remote power supply (e.g., a power supply mounted on the boat 10) that conveys power to the lure driver through the fishing lines 5, 20. In still other embodiments, the lure driver 40 can include an onboard generator for driving the propulsion and/or pumping system of the lure driver. For example, the lure driver 40 can include a solar power generator, a water current-driven power generator, a tide-driven power generator, or the like.

The lure drivers 40 are suitably configured to drive the lures 60 as a swarm to simulate a school of bait fish and/or maintain separation between the lures and hooks 50 within each rig 3 and among the multiple rigs 3. As described below, each of the lure drivers 40 can include a position transmitter for transmitting a position signal (e.g., a wireless position signal or a position signal transmitted over the leader lines 5 and the main line 20) representative of the position of the lure driver in the body of water W. In certain embodiments, the lure drivers 40 are configured to receive the position signals from the other lure drivers on the rigs 3 and include onboard propulsion controllers for using the position signals (and, in some embodiments, other signals representative of other parameters such as water dynamics parameters representative of the motion within the body of water W caused by tides, currents, disturbances, and the like) to determine a propulsion scheme for maintaining separation between the lure drivers 40, the lures 60, and the hooks 50 of each rig 3. Such a propulsion scheme may implement similar control logic that is used to maintain separation between aerial drones in a drone swarm. In some embodiments, a centralized control system (discussed below) receives the position signals from each of the lure drivers 40 and transmits control signals to the lure drivers for maintaining separation between the lures 60 and the hooks 50. Maintaining separation between the lures 60 using the drivers 40 can increase the number of fish that are caught using one rig 3. After one fish is captured on one of the leader lines 5, the other lure drivers 40 can maintain separation from the captured fish to attract and catch more fish on the same rig 3.

The lure driver 40 can, in some embodiments, be configured to continuously drive the lure 60 to move in a pattern of motion for attracting fish to the lure. Suitable patterns of motion for attracting fish may drive the lure 60 in motion that simulates the swimming of a baitfish or a jellyfish, for example. To configure the lure driver 40 for driving the lure 60 in the desired pattern of motion, the lure driver may be connected to the leader line 5 proximate the lure 60 or at point where leader line attaches to the main fishing line 20. The lure driver 40 may be configured for driving the lure 60 in a side-to-side or up-and-down pattern of motion to mimic a baitfish. In some embodiments, the lure driver 40 is installed on the lure 60 itself. Suitably, the lure driver 40 can be installed on the lure 60 so as to resemble part of the lure to aid in attracting fish to the lure. Installing the lure driver 40 in the lure 60 can provide for more precise control over the motion of the lure. As explained below, each of the illustrated lure drivers 40 may be remotely controlled by the remote controller 13 positioned on the boat 10 and configured to direct the lure drivers to drive movement of the lures 60 toward likely locations of fish in the body of water W.

As discussed above, the illustrated fishing lines 20 are deployed from the stern or rear of the boat 10. In this configuration, the lure drivers 40 may be configured for controlling the depth of the lures 60 and/or continuously driving the lures in a pattern of motion for attracting fish to the lures as the boat 10 travels forward through the body of water W. In some embodiments, the lures 60 are also configured to passively move in a pattern of motion that attracts fish to the lures (i.e., without being driven in the passive pattern of motion by the lure driver 40) and/or to passively move apart from one another in response to forward movement of the boat 10 through the body of water W (e.g., during trolling).

In other embodiments, the lure drivers 40 can be configured to control the lateral positioning of the lures 60 in the body of water 60. For example, when the boat 10 is not being driven through the body of water W, the lure drivers 40 can be used to guide the lure 60 to be positioned near a location where there is determined to be a reasonable likelihood that one or more fish are located in close proximity (i.e., a selected fishing location; methods and systems for determining the selected fishing location are described below). It is understood that the fishing lines 20 could be deployed from sides of the boat 10 when the boat is not being driven through the body of water W. As can be seen, the lure driver 40 can function to position the lure 60 at the desired depth without installing leaden weights on the lines 5, 20 and likewise to position the lure adjacent a selected fishing location without moving the boat 10 through the body of water W or recasting the fishing line. For example, fish might be determined to be likely present at a location 40-50 feet to one side or another of the boat. Rather than repositioning the boat 10 or recasting the line 20, the lure driver 40 moves the hook 50 and the lure 60 toward the selected fishing location.

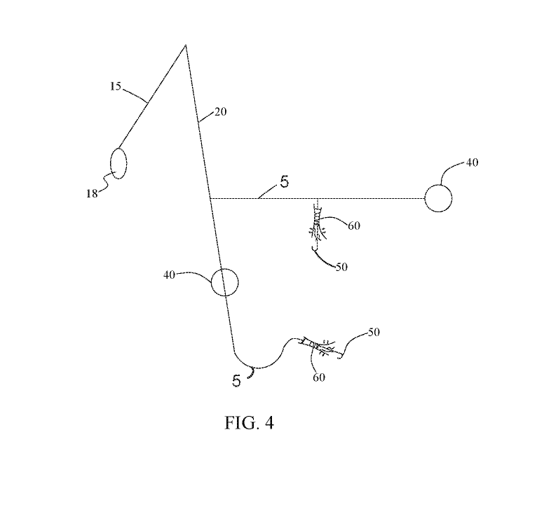

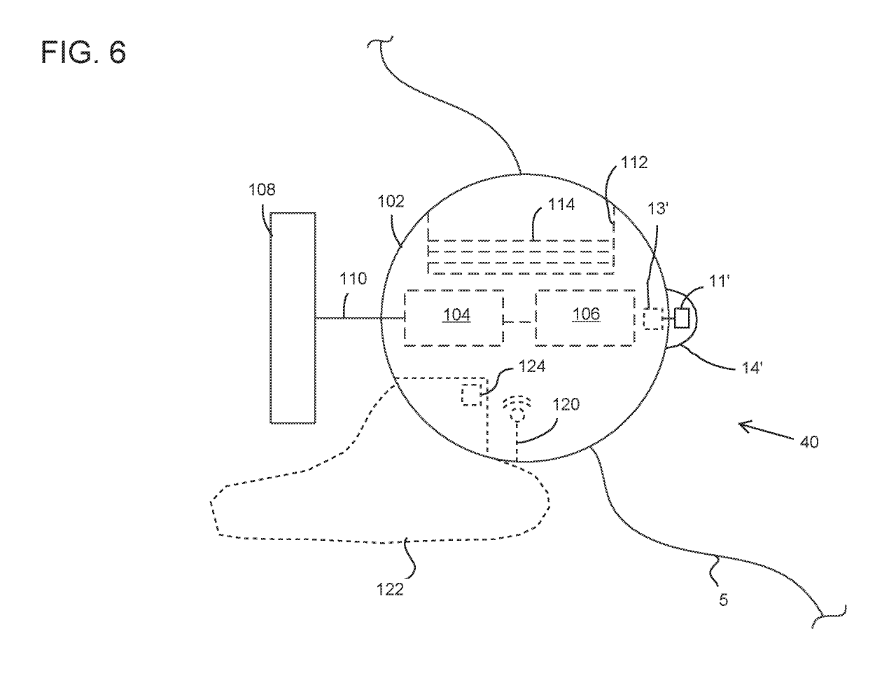

One exemplary embodiment of a lure driver 40 is shown in FIG. 6. The lure driver 40 includes a housing 102, which may be partially formed of foam or another buoyant material. The housing 102 is operatively connected to the leader line 5 proximal of the hook 50 and the lure 60. In other embodiments, the housing 102 is connected to the leader line 5 distal of the hook 50 and the lure 60. For example, FIG. 4 illustrates a rig 3 including one leader line 5 having the lure driver 40 connected distal of the lure 60 and another leader line having the lure driver connected proximal of the lure. Referring again to FIG. 6, the housing 102 defines a cavity that receives a drive 104 and a power supply 106 of a propulsion system. In the illustrated embodiment, the drive 104 comprises an electric motor and the power supply 106 comprises a battery. A drive shaft 110 connects the motor 104 to a propeller 108 such that the motor drives rotation of the propeller to propel the lure driver 40 through the body of water W. It is understood that the drive shaft 110 can be adjustable for changing the thrust vector of the propeller 108 for steering the driver 40 or the lure driver could include a rudder for steering. The lure driver 40 further includes an adjustable ballast vessel 112. The adjustable ballast vessel 112 is configured to receive a selected amount of ballast 114 to provide the lure driver 40 with buoyancy that positions the lure driver at a desired depth. In one embodiment, the angler manually places solid weights (e.g., leaded weights) in the vessel 112 to form the ballast 114. In another embodiment, the lure driver 40 includes a pump (not shown) for selectively pumping water into the vessel 112 to form the ballast. In the illustrated embodiment, the lure driver 40 further comprises a transmitter 120 for wirelessly transmitting a position signal as discussed above. The transmitter 120 can suitably comprise a sonar transmitter, an RF transmitter, a UV transmitter, an IR transmitter, an acoustic transmitter, etc. In addition or in the alternative, the lure driver 40 can be configured to transmit a position signal and/or other signals (e.g., water dynamic signals) to the other lure drivers or a centralized control system through the leader line 5 and the main line 20.

In one or more embodiments, the lure driver 40 can include an onboard data collection system 7′. For example, the illustrated lure driver 40 includes a lightweight sonar 14′ or other fish finder and one or more additional sensors 11′. These sensors 11′, 14′ provide enhanced fishing parameter data at the location of the lure driver 40. The data from the sensors 11′, 14′ can be transmitted to the controller 13 wirelessly or over the fishing lines. In addition, the data from the sensors 11′, 14′ can be transmitted to a local controller 13′ for locally controlling the driver 104 for moving the lure 60 for the purpose of attracting a fish. The controller 13′ can also be linked to a GPS system or other navigation system. If the lure driver 40 is detached from fishing line 20 or boat 10, the controller 13′ can use GPS to automatically come to the surface and navigate toward the boat 10 or other location (broadly, a retrieval location) for retrieval. To maintain the separated lure driver 40 on the surface of the body of water W even after its power supply 106 is empty, the lure driver can include a selectively deployable flotation device 122. In the illustrated embodiment, the flotation device 122 comprises a balloon that is connected to a pressurized gas canister 124 configured for selectively inflating the balloon. When the balloon 122 is inflated, it floats on top of the surface of the water W to allow for retrieval of the lure driver 40.

Referring again to FIGS. 1A and 1B, the data collection system 7 includes one or more sensors 11 for sensing fishing parameters that can be used to determine a likely location of fish in the body of water W and/or to make other determinations relevant to catching fish from the body of water. Any sensor for detecting a parameter relevant to the likely location of fish in the body of water may be used. In an exemplary embodiment, the data collection system 7 includes a fish finder 14, which can be used to identify the location of fish in the body of water W. Various types of fish finders are known in the art. For example, fish finders that use sonar, a laser scanner, one or more cameras, an infrared detector, an ultraviolet scanner, etc., may all be used in one or more embodiments. It is understood that the data collection system 7 can include more than one fish finder 14, such as two or more fish finders of different types. In addition to fish finders, other types of sensors 11 may also be used in the data collection system 7 to identify the likely location of fish. For example, in certain embodiments, the sensors 11 include a GPS sensor for providing GPS positioning data, a temperature sensor for sensing an environmental temperature (e.g., air or water temperature), a barometric pressure sensor for sensing barometric pressure, water dynamic sensors for sensing water dynamics such as current or tide, a wind sensor, a depth sensor, and/or a camera for providing image data related to water conditions, structure, debris, or the like. In some embodiments, one or more of the sensors 11 may include a satellite sensor that remotely provides a fishing parameter signal to the data collection system 7. As explained below, each of the sensors 11 and the fish finder 14 are configured to transmit a fishing parameter signal to the controller 13 that is representative of the sensed fishing parameter, and the controller is configured to use the fishing parameter signal(s) to determine a selected fishing location and provide navigation instructions to the lure drivers 40 for driving the lures 60 toward the selected fishing location.

In the illustrated embodiment, the data collection system 7 includes a mechanical lift 70 that is mounted on the boat 10 for selectively raising and lowering at least some of the sensors 11 (others of the sensors can be mounted at other locations on the boat 10). The illustrated lift 70 comprises a telescoping lift, which can be driven hydraulically, manually, or using a tether or cable drive system. When the sensors 11 mounted on the lift 70 are not in use, the lift can be retracted. The height of the lift could be controlled manually or be automated by the controller 13. As explained in further detail below, other types of lifts such as aerial drones can also be used in other embodiments.

In one embodiment, the sensor 11 comprises a camera mounted on the lift 70 for selective rotation about the lift axis (e.g., a vertical axis) and at least one other axis transverse to the lift axis (e.g., using a multiaxial pivoting mount). Depending on the height of the camera, the angle of the camera with respect to the lift axis can be adjusted so that the camera is pointed toward the segment of the body of water W at the desired radial distance from the lift 70. The camera of the sensor 11 can be continuously or periodically rotated about the lift axis to provide 360-degree image data of the surface of the water W within a possible fishing zone adjacent the boat 10. In some embodiments, the controller 13 uses the image data to automatically identify the location of fish in the body of water W or obstacles in the body of water that must be navigated around to drive a lure 60 to a selected fishing location. As discussed below, in other embodiments, the image data is provided to a fisherman who analyzes the image data to determine the location of fish and/or the location of any obstacles and provides inputs representative of the location of fish and/or obstacles to the controller. In one embodiment, the camera of the sensor 11 is a telescopic camera equipped with a high powered lens such as an adjustable telephoto lens or a UV lens. The lens can include various optical enhancements such as adjustable filters that enable selective adjustment of the features that are visible in the image data. The camera can have a self-cleaning function such as a spray and/or wipers so that salt, air, or other contaminants can be cleared from the lens. In addition, the camera can be equipped with night vision to provide image data under low light conditions. In addition or as an alternative to the camera, the sensor 11 may comprise other sensor mounted on the lift 70 in a similar fashion to provide 360-degree parameter data of the surface of the body of water W. Instead of mounting the camera or other sensors for rotation, the sensor 11 can include three or more wide angle cameras or sensors mounted on the lift 70 to provide continuous 360-degree data about the surface of the body of water W extending around the boat.

In one or more embodiments, the data collection system 7 can include, or be operatively connected to, the navigation system of the boat 10. Using navigation data from the navigation system (e.g., a GPS system) the data collection system 7 could be configured, in some embodiments, to position the camera of the sensor 11 for providing image data of a specific location. The image data could be combined (e.g., using the controller 13) with other fishing parameter data, including data from a fish finder 14 that is trained on the same location or data from a radar scanner, laser scanner, UV scanner, and/or IR scanner trained on the same location.

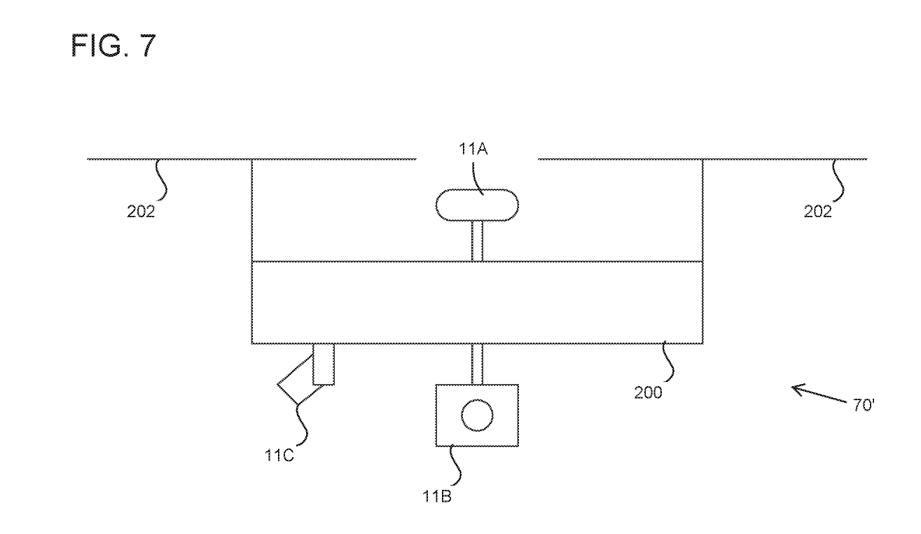

Referring to FIG. 7, in one embodiment, the data collection system 7 includes an aerial drone 70′ that functions as a lift for lifting one or more sensors, such as sensors 11A, 11B, 11C in the present embodiment, to a desired height above the surface of the body of water W. The illustrated drone 70′ includes a frame 200 and four vertically oriented propellers 202 for providing lift and lateral propulsion. Radar 11A is mounted atop the frame 200, and a camera 11B and a laser scanner 11C are mounted on the bottom side of the frame. The radar 11A can be configured to track movement of the boat 10 to coordinate movement of the drone 70′ with the movement of the boat. Each of the sensors 11A, 11B, 11C can be mounted on a rotating mount and/or a gimbal for enhanced mobility and stabilization. The sensors 11A, 11B, 11C are configured to wirelessly transmit respective signals to the controller 13 for use in controlling the lure drivers 40. In some embodiments, the sensors 11A, 11B, 11C are configured to sense changes in water temperature, waves, water color, etc. These parameters may be used to detect underwater debris, hazardous underwater structure, and the like.

Referring back to FIG. 1A, the controller 13 is installed on the boat 10. The controller 13 can be operatively connected to the data collection system 7 for receiving fishing parameter signals from the sensors 11. For example, the controller 13 can be wirelessly connected to the data collection system 7 or connected via a hardwire connection to the sensors 11 and the fish finder 14. In one or more embodiments, the controller is configured to analyze the fishing parameter signals to determine a likely location of the fish in the body of water W. For example, the controller 13 can evaluate color and depth in image data from the camera of the sensor 11 to determine the location of aquatic structure that is likely to attract or protect fish. Likewise, the controller 13 can identify the presence of one fish or a school of fish from the image data. The controller 13 can compile the image data with other data, such as data from the fish finder 14, and use the compiled data to determine the selected fishing location. It is understood that while the controller 13 is illustrated as a single device, the controller can include multiple control modules that run on multiple processors and devices in other embodiments.

In some embodiments, the controller 13 includes a memory that stores fish location analytic data that includes data about the likely location of fish in one or more specified bodies of water at one or more specified times of year. For example, the fish location analytic data can indicate the types of structure in which fish are likely to be found, the depths at which fish are likely to be found, the water temperatures at which fish are likely to be found, the kinds of fish that are likely to be present at various locations within the body of water, etc. The controller 13 can suitably be configured to cross-reference fishing parameter data such as temperature data, barometric pressure data, location data, depth data, etc., with the stored fish location analytic data to determine preferred locations for fishing under the sensed conditions. The controller 13 can combine the analytical determination of preferred fishing locations with the data from the camera 11 and/or the fish finder 14 to further enhance the determination of the selected fishing location.

Suitably, the controller 13 can be operatively connected to a display 13A (FIG. 1A) configured to display certain fishing parameter data to the fisherman on the boat 10. For example, the controller 13 can display 13A the image data from the camera 11 on the display. In some embodiments the display 13A and the controller 13 can be included in a single device such as a tablet computer, smartphone, or laptop computer. The fisherman can view the data on the display 13A and determine a selected fishing location. In one or more embodiments, the display 13A is a touch screen display, though other input devices can also be used in other embodiments. The fisherman can input the selected fishing location to the controller 13 by for example touching the display 13A at a location on the displayed image that corresponds to the determined selected fishing location. Based on the received input from the fisherman, the controller determines the location indicated by the fisherman to be the selected fishing location.

After determining the selected fishing location using the fishing parameter signals from the data collection system 7, the controller 13 remotely controls the lure drivers 40 to drive the lures 60 toward the selected fishing location. For example, the controller 13 transmits a navigation signal to the lure drivers 40 (e.g., wirelessly or over the fishing lines 5, 20). The navigation signal can, for example, include directions for avoiding obstacles identified from the image data. The lure drivers 40 receive the navigation signal and automatically navigate toward the selected fishing location according to the directions.

In one or more embodiments, the controller 13 is also configured to determine when the lure driver 40 and/or lure 60 becomes separated from the boat 10. For example, in certain embodiments, the fishing lines 5, 20 are electrically conductive and the controller 13 is configured to monitor a current passing through the fishing lines. When the amount of current passing through the fishing lines changes, the controller 13 can determine that a portion of the line has become separated from the boat 10. Suitably, the controller 13 can wirelessly provide navigation instructions to the lure driver(s) 40 associated with the separated portion of fishing line to direct the lure drivers back toward the boat 10 for retrieval. The controller 13 can also be configured to determine the position of the separated lure drivers 40 using the position signal transmitted using the wireless transmitter 120 (FIG. 6). The controller 13 can display the position on the display 13A so that the lure driver 40 can be retrieved.

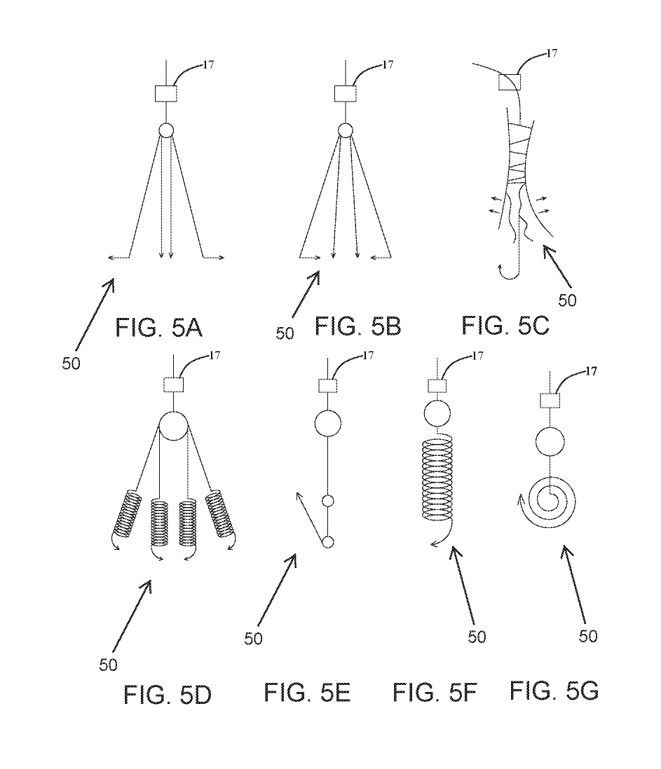

In one or more embodiments, the fishing system 1 includes a notification system configured to determine when a fish is captured on the line 20 and ready to be retrieved. In such a notification system, the controller 13 can be configured to monitor the current flow through the fishing lines 5, 20. A change in current through the fishing lines 5, 20 can indicate a change in tension in the fishing lines. Thus, when a fish strikes the lure 60 and is captured by the hook 50, the tension in the respective lines 5, 20 changes and a corresponding change in the current flow through the fishing lines can be detected. By monitoring the current flow through the fishing lines 5, 20, the controller 13 can thus determine when a fish is on the line and provide a suitable indication to the fisherman using, for example, the display 13A or other indication. In some embodiments, the notification system can also be implemented using the image data from the camera of the sensor 11. A change in line slack can be determined visually, and the controller 13 can thus determine when a change in line slack occurs by monitoring the image data related to the visible portion of the main fishing line 20. Referring to FIG. 5, the illustrated fishing system 1 also includes a strain or pressure sensor 17 that is operatively connected to each of the leader lines 5 adjacent the lure 60 to detect the strain in the leader line. The sensor 17 is configured to detect changes in tension or movement of the leader line 5, for example, when a fish strikes the lure 60 and is captured by the hook 50. The sensor 17 is operatively connected to the controller 13 via either a wireless connection or the fishing lines 5, 20 to provide a signal to the controller. The controller 13 can determine when a strike has occurred and when a fish is hooked on the hook 5 based on the signal from the sensor 17. Thus, it is understood that any of the current monitoring system of the controller 13, the camera 11, and the sensor 17 can be used as a fish-capture sensor of the notification system. Still other types of fish-capture sensors, such as movement sensors, pressure sensors, tension sensors, etc. may be used in other embodiments.

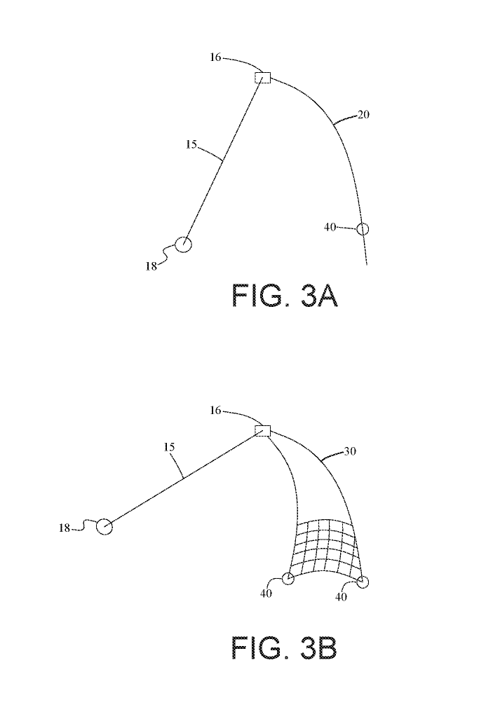

Referring to FIG. 3A and 3B, the fishing system 1 comprises the reel 18 mounted on the deck of the boat 10, a fishing rod 15, and the fishing lines 20 or fishing nets 30. In FIG. 3A, the fishing line 20 is connected to the fishing rod 15, and in FIG. 3B, the fishing net 30 is connected to the fishing rod. In addition, a waterproof housing is mounted on the tip of the fishing rod 15 for receiving a sensor 16. The sensor 16 is operatively connected to the controller 13 to transmit a signal representative of the movement of the tip of the fishing rod 15. The controller 13 can use the signal from the sensor 16 to identify irregular movement such as deflection of tip of fishing rod 15 that can, for example, indicate that fish is on the line. The controller 13 can be configured to automatically indicate that a fish is ready for retrieval or automatically retrieve the fish as described below. The sensor 16 can also be configured to detect movements that may indicate dynamic conditions in the body of water W. The sensor 16 transmits information about fishing conditions to the controller 13 for use in determining the selected fishing location. In one such embodiment, the fishing system 1 uses a GPS device to correlate the data from the sensor 16 with the location at which it was sensed.

In some embodiments, an automatic retrieval system can be configured to automatically retrieve a captured fish after it is detected by the fish-capture sensor of the notification system. For example, as shown in FIG. 1B, the fishing line 20 is wound onto a reel 18 that is operatively connected to a reel driver 18A for automatically winding the fishing line 20 onto the reel. The reel driver 18A is in communication with the controller 13. When the notification system detects a fish on the line 50, 20, the controller 13 communicates to the reel driver 18A to respond by winding the fishing line 20 onto the reel to retrieve the captured fish. Suitably, the reel driver 18A can be selectively activatable so that the fisherman can determine when a fish is to be automatically retrieved or when the fisherman is to manually retrieve the fish using the reel 18. In the latter case, an indication (e.g., an audible or visual indication) is provided to the fisherman when the notification system detects a fish on the line 20, 5.

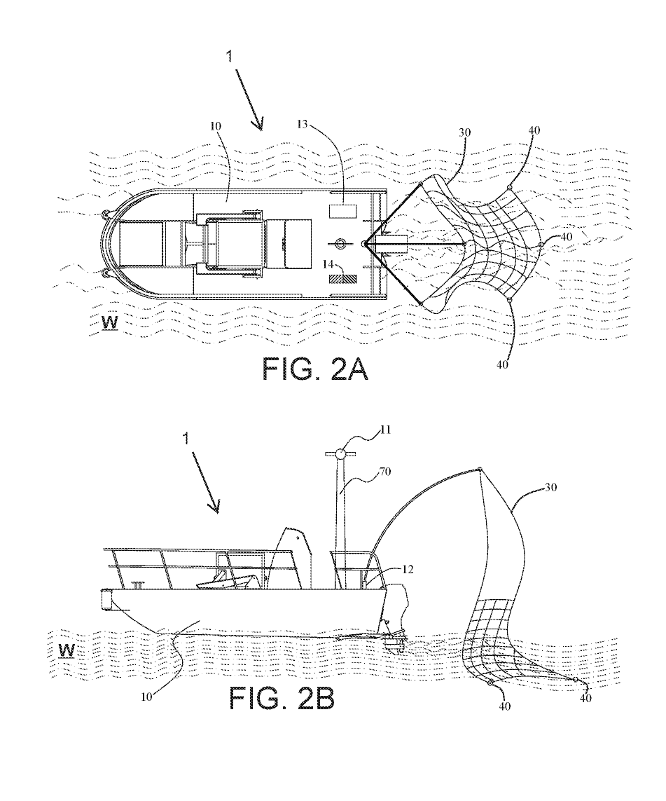

Referring to FIGS. 2A and 2B, instead of fishing lines 20, one or more fishing nets 30 can be used as a submersible fishing implement of the fishing system 1. One or more net drivers 40 are connected to one or multiple corners of the net 30. Once the net 30 is thrown into the water, the controller 13 automatically controls the net drivers 40 to selectively expand or open the net to receive fish and selectively collapse the net to entrap or capture fish. For example, to open the fishing net 30, the controller 13 can direct the net drivers 40 to spaced apart locations that maintain the net in an open configuration. When the desired fish are present in the capture area of the net 30, the controller 13 directs the net drivers to travel toward one another to collapse the net and capture the fish. The presence of fish in the net 30 can be detected using any suitable sensor. For example, sensors such as cameras and scanners that detect the location of a fish in the net may be used and/or sensors that detect deformation of the net caused by forces a fish imparts on the net can also be used in addition or in the alternative. As above, in one or more embodiments, the controller 13 is configured to direct the net drivers 40 to drive the net to a selected fishing location determined using the fishing parameter data from the data collection system 7. For example, the net drivers 40 can adjust the depth and/or lateral positioning of the net 30. In certain embodiments, after capturing fish in the net 30, the net drivers 40 can be configured to automatically drive the net and captured fish back toward the boat 10 for retrieval.

Referring to FIG. 4, as discussed above, in some embodiments, signals (e.g., electrical or optical signals) are transmitted over the fishing lines 5, 20 to power the lure driver 40 and communicate between the lure driver and the controller 13. To make further use of the signals transmitted over the lines 5, 20, in some embodiments, the lure 60 can include signal-responsive elements that generate kinetic energy in response to the signals transmitted over the fishing lines. For example, the lure 60 may comprise electrically responsive elements that are operatively connected to the leader lines 5. The electrically responsive elements may cause the lure 60 to move in response to current conveyed over the lines 5, 20 to imitate the pattern of movement of a baitfish or to expand and contract like a jelly fish. Various electromotive elements may be used including, for example, magnets, nitinol, or other spring loaded devices.

Any suitable type of lure 60 may be used. For example, lures 60 comprising springs or balloons configured to periodically expand and contract the lure may be used. Likewise, lures 60 configured to passively flutter, vibrate, create sound, and move in a swimming motion in response to movement through the water may also be used. It is understood that different lures 60 are more effective for different types of fish, and therefore, it may be desirable to change the lures 60 rather simply changing the motion pattern of an established lure 60 to attract the fish. In one embodiment, instead of substituting one lure for another, the lure 60 can comprise an adjustable body whose shape is selectively adjustable based on movement of the lure through the body of water. The lure driver 40 can be used to selectively adjust the shape of the lure 60 by adjusting the movement of the lure through the water. In other embodiments, the lure 60 includes a drive mechanism for changing the shape of the lure. The drive mechanism may be powered and/or actuated by signals conveyed via the fishing lines 5, 20 and/or wireless signals. The shape of a lure 60 may be changed, for example, in response to fishing parameter data that indicates a particular type of fish is likely to be at a selected location in the body of water W. The adjusted shape of the lure 50 would make the lure more attractive to the identified type of fish. Similarly, the controller 13 can be configured to control the lure driver 40 to drive the lure 60 in a pattern of motion that is specifically configured to attract the identified type of fish.

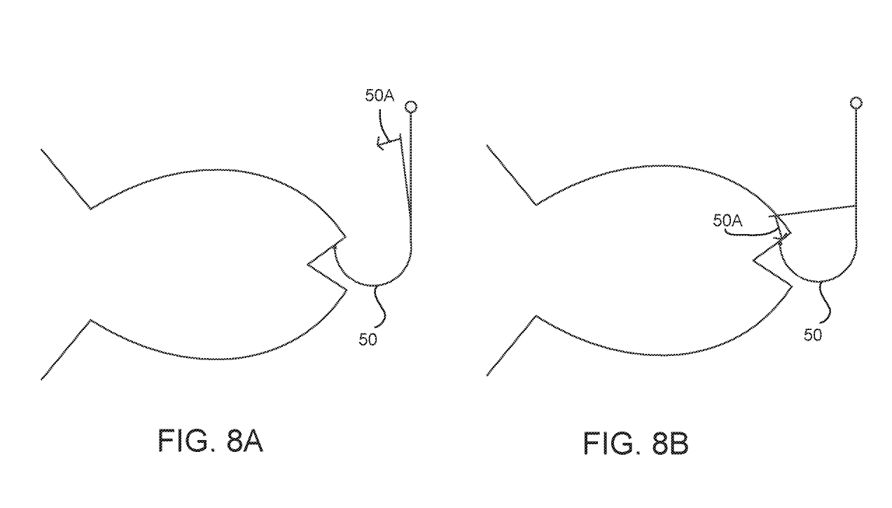

Referring to FIG. 5, any suitable type of hook 50 may be used with the fishing system 1. Referring to FIGS. 8A and 8B, an exemplary hook 50 includes a spring loaded barb member 50A configured to be selectively closed in response to a force imparted on the hook. For example, the hook can include a mousetrap mechanism for deploying the barb member 50A of the hook 50 when a fish contacts the hook with a predetermined force. When the barb member 50A of the hook 50 is deployed, it swings toward the barbed end of the hook so that a portion of the fish (e.g., the lip) is captured between the barbed end and the spring loaded barb member. The hook 50A is thus automatically set, even when a fish does not catch itself on the hook with its strike and without any response on the part of the fisherman. Referring to FIG. 5, in other embodiments, the hook 50 may spring open in other ways to further engage the mouth or jaw of the fish to automatically capture the fish on the hook. In certain embodiments, the hook 50 is made of nitinol, steel or polymer which is thermally activated, or mechanically activated.

The strain or pressure sensor 17 may be built into the hook 50. The sensor 17 can detect when the hook 50 expands or bends to ensnare the fish once it strikes the lure 60 and to provide a signal to the controller 13. The sensor 17 may be used in aggressive sport fishing (e.g., tuna fishing or live bait fishing) for distinguishing true strikes from movements caused by a fish merely toying with the lure 60 or movements of the bait fish. In some embodiments, the sensors 17 can be operatively connected to the activation mechanism that causes the hook 50 to expand or deform to ensnare the fish. For example, actuation of the mechanism may be inhibited until the sensor 17 detects a strike of a minimum predetermined force that corresponds with the strike force of the type of fish that is being pursued.

As explained above, in some embodiments, the fishing lines 5, 20 are configured to convey electrical signals to and from the lure driver 40 and/or the lure 60. Suitably, the fishing lines 5, 20 comprise a shielded conductor. In some embodiments, the sensors 17 are built into the fishing lines 20 (or the fishing net 30). As explained above, inline sensors 17 allow changes in the tension in the fishing lines 5, 20 to be monitored in order to detect strikes, inadvertent lure separation, etc. Furthermore, a line tension signal can be fed back to the controller 13 or the reel driver 18A to actively control the retrieval of a fish on the line. When the signal indicates that the tension in the line is too high for the fish or risks breaking the line, the controller 13 can slow the rate at which the driver 18A is winding line on the reel 18. The tension signal can also be combined with other data such as fish type data determined using the camera of the sensor 11 and analytical data stored on the data collection system memory to optimize the retrieval rate for the type of fish that is on the line. The controller 13 is suitably configured to receive the tension signals and determine whether tension is imparted by a bait fish, hazard, or fish on the line. Such determinations may be made comparing the real-time tension data with tension data stored on a memory that was empirically derived and represents the tension response of bait fish, hazards, and various types of fish that may be caught.

Further, the fishing system 1 is, in some embodiments, operatively integrated with a remote server application or app, which, for example, provides satellite data to the controller for identifying the location of the boat relative to debris, birds, etc. Such an application can further allow for the tracking of fish in real time. For example, the data collection system 7 can be remotely connected to the application to send fishing parameter data to the application for storage and later use in developing fishing analytics.

The foregoing descriptions of specific embodiments of the present disclosure have been presented for purposes of illustration and description. They are not intended to be exhaustive or to limit the invention to the precise forms disclosed, and obviously many modifications and variations are possible in light of the above teaching. The exemplary embodiment was chosen and described in order to best explain the principles of the invention and its practical application, to thereby enable others skilled in the art to best utilize the invention and various embodiments with various modifications as are suited to the particular use contemplated.

Modifications and variations of the disclosed embodiments are possible without departing from the scope of the invention defined in the appended claims.

When introducing elements of the present invention or the embodiment(s) thereof, the articles “a”, “an”, “the” and “said” are intended to mean that there are one or more of the elements. The terms “comprising”, “including” and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

1. A fishing system for capturing fish in a body of water, the fishing system comprising:
a submersible fishing implement and configured to catch one or more fish in the body of water;
an implement driver configured to drive movement of the submersible fishing implement when the submersible fishing implement is submerged in the body of water;
a data collection system comprising one or more sensors configured to sense one or more fishing parameters and transmit a fishing parameter signal representative of the one or more fishing parameters;
a controller operatively connected to the data collection system and configured to receive the fishing parameter signal and to determine, based on the received fishing parameter signal, a desired fishing location in the body of water, the controller being further configured to transmit a navigation signal to the implement driver operative to control the implement driver to move the submersible fishing implement toward the selected fishing location in the body of water.

2. A fishing system as set forth in claim 1, wherein the data collection system comprises a lift, the one or more sensors being mounted on the lift and the lift being configured to selectively raise and lower the one or more sensors.

3. A fishing system as set forth in claim 2, wherein the lift comprises an aerial drone.

4. A fishing system as set forth in claim 1, wherein the implement driver comprises one of a motor drive, a jet drive, and a propeller drive.

5. A fishing system as set forth in claim 1, wherein the implement driver is configured to selectively adjust the depth of the submersible fishing implement in the body of water.

6. A fishing system as set forth in claim 1 further comprising a notification system including a fish-capture sensor configured to detect when the submersible fishing implement has captured one or more fish.

7. A fishing system as set forth in claim 6, further comprising a retrieval system including a retrieval driver configured to drive movement of the fishing implement and the captured fish to a retrieval location.

8. A fishing system as set forth in claim 1, wherein the submersible fishing implement comprises a net.

9. A fishing system as set forth in claim 1, wherein the submersible fishing implement comprises a hook and a lure.

10. A fishing system as set forth in claim 9, wherein the implement driver is further configured to continuously drive the lure to move in a pattern of motion for attracting fish to the lure.

11. A fishing system as set forth in claim 1, wherein the submersible fishing implement comprises a rig comprising a main line having a main line end, a plurality of leader lines extending from the end of the main line to respective leader line ends, and at least one lure secured to each leader line.

12. A fishing system as set forth in claim 10, wherein the implement driver comprises a plurality of lure drivers, each lure driver being operatively connected to one of the leader lines to separately drive movement of a corresponding one of the lures.

13. A fishing system as set forth in claim 1, wherein said one or more sensors comprises at least one of a camera, a laser scanner, an ultraviolet scanner, an infrared scanner, a radar detector, a temperature sensor, a pressure sensor, and a fish finder.

14. A fishing system as set forth in claim 1, wherein the implement driver is submersible.

15. A fishing system as set forth in claim 1, further comprising a display operatively connected to the controller, the display being configured to display data from the fishing parameter signal to a user for determining the desired fishing location.

16. A fishing system as set forth in claim 15, further comprising a user input device configured to receive a user input identifying the desired fishing location determined from the displayed data, the controller being configured to determine the desired fishing location based on the user input.

17. A fishing system as set forth in claim 1, further comprising a line having a first end portion and a second end portion, the fishing implement being connected to the line adjacent the second end portion thereof.

18. A fishing system as set forth in claim 17, further comprising a connection sensor configured to sense disconnection of the fishing implement from the first end portion of the line.

19. A fishing system as set forth in claim 18, wherein the implement driver is configured to automatically drive the implement driver and the fishing implement toward the first end portion of the line when the sensor senses disconnection of the fishing implement from the first end portion of the line.
